(19) United States
(12) Patent Application Publication
(10) Pub. No.: US 2012/0152863 A1
(43) Pub. Date: Jun. 21, 2012

(54) LIQUID EXTRACTION FILTER AND METHOD FOR CLEANING IT

(76) Inventors: Bjarne EKBERG, Turku (FI); Olli Högnabba, Kantvik (FI); Jason Palmer, Brisbane (AU)

(21) Appl. No.: 13/404,261

(22) Filed: Feb. 24, 2012

Related U.S. Application Data
(63) Continuation of application No. 12/936,475, filed on Oct. 5, 2010.

(30) Foreign Application Priority Data
Apr. 11, 2008 (FI) 20080281

(51) Int. Cl. B01D 29/66

(52) U.S. Cl. 210/797; 210/139; 210/96.1; 210/85

(57) ABSTRACT

A liquid extraction filter, more particularly a continuous-action, top-feed, vacuum drum filter includes a drum structure and filter elements, the filtration surface of which filter elements is formed of microporous hydrophilic material such that when filtering with a partial vacuum it is impervious to the surrounding air.

### CROSS-REFERENCE TO RELATED APPLICATION

The present application is a continuation of U.S. patent application Ser. No. 12/936,475 filed on Oct. 5, 2010, the entire contents of which are incorporated herewith by reference.

### FIELD OF THE INVENTION

The object of this invention is a liquid extraction filter, more particularly a continuous-action, top-feed, vacuum drum filter, as defined in the preamble of claim 1, and a method as defined in the preamble of claim 6, and a use as defined in the preamble of claim 12 for applying the invention.

### BACKGROUND OF THE INVENTION

The invention relates to a liquid extraction filter, the field of application of which is the extraction of the liquid of various sludges, such as mineral sludges, chemical precipitations or organic sludges. The task of the filter is to remove liquid from a flow of sludge such that the end-result is a flow of solid matter that has the pre-required, or as low as possible, residual moisture and, correspondingly, a flow of liquid that has as little solid matter as possible.

The filter works extremely well with dense sludges, the particles of solid matter of which are exceptionally large and/or heavy, in which case it is awkward or impossible to form a cake of filterpress by raising from the sludge settling tank. The filter works preferably also for materials which cause rapid clogging of the filter mediums, such as e.g. many organic materials.

Generally, the level of prior art is described in patent publications FI 61739, FI 76705, FI 82388 and FI 118254. It should be noted that with prior-art filters it is very difficult or impossible to filter sludge that contains very large (>100 micrometers) and heavy particles. The gravity exerted on the particles and the currents occurring in the tank form a problem. Forces are exerted on the particles that are much greater than the forces produced by the suction of the filter medium, and the particles do not adhere to it but instead remain in the tank. Thus the filter medium comes out of the sludge without cake.

### DESCRIPTION OF THE INVENTION

A new solution has now been developed to eliminate the problems of prior art. The characteristic features of the solution according to the invention are defined in more detail in the characterization parts of the attached claims.

The invention relates more particularly to a top-feed drum filter, which operates on the capillary principle, i.e. the filter elements are constructed of a microporous, hydrophilic material, the bubble point of which is sufficiently high to prevent the penetration of air. The material used can be a ceramic, such as Al₂O₃ or a mixture of silicates and Al₂O₃. Alternatively the material can be a plastic material such as e.g. polyamide or polyacryl. Also a metallic material such as stainless steel can be used or possibly some combination of the materials presented above.

### DESCRIPTION OF THE DRAWINGS

In the following, the invention will be described in more detail with reference to the attached drawings, wherein

FIG. 1 and FIG. 3 present a schematic diagram of the filter according to the invention.

FIG. 2 presents the capacity of the filter according to the invention as a function of time, without ultrasound cleaning and with ultrasound cleaning.

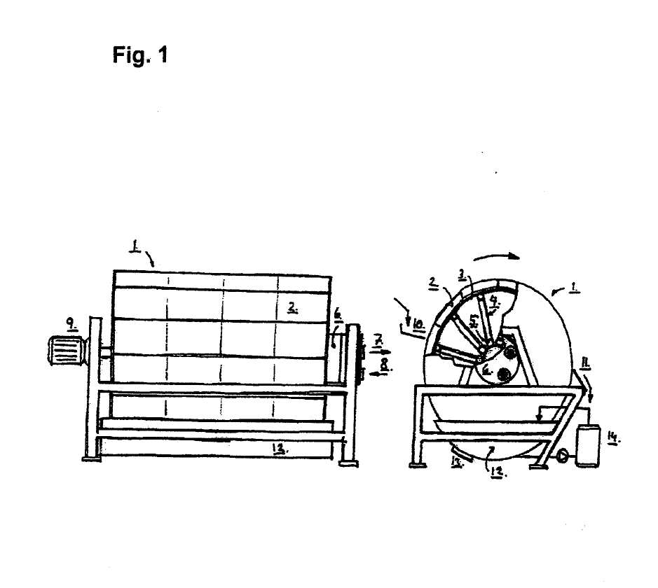

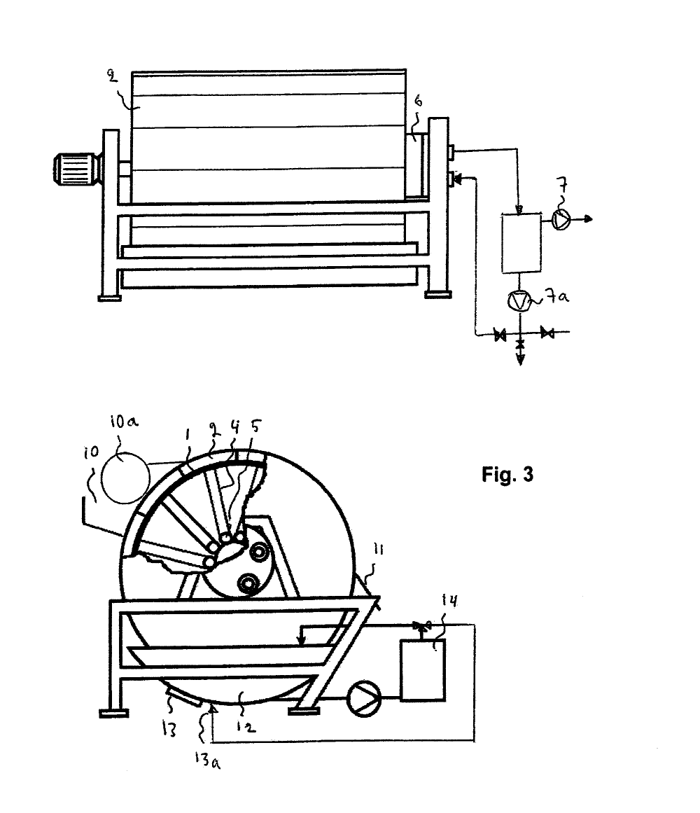

According to FIG. 1 and FIG. 3 the filter comprises a drum structure (1), which functions as a support for the filter elements (2). The shape of the filter elements is such that they form a round and essentially continuous surface. The filter elements are disposed in rows and each filter element is connected to the vacuum system of the filter with a hose (4). In the longitudinal direction of the drum are collector pipes (5), the task of which is to connect the filter elements that are disposed in the same row; i.e. there are as many collector pipes as there are rows of filter elements. The collector pipes are connected to a distributing valve (6) disposed on the axis of the filter, the task of which distributing valve is to transmit the partial vacuum or overpressure to the filter elements. The distributing valve comprises zones such that a part of the filter elements contain a partial vacuum (in this case there is cake formation and cake drying) or overpressure (in which case cleaning of the filter elements with water is performed with reverse pressure). If a long drum is used, it can be advantageous to dispose the distributing valve at both ends of the drum.

The vacuum system comprises a filtrate reservoir and a vacuum pump (7) and a filtrate pump (7a). The vacuum pump maintains a partial vacuum in the piping of the filter and the filtrate pump removes the filtrate. It is possible to arrange reverse flushing (8) either such that some of the filtrate is led back to the filter by means of the filtrate pump or such that an external water source is used.

A motor with gears (9) rotates the drum structure. The speed of rotation is steplessly adjustable typically in the range of 1-5 revolutions per minute.

The material to be filtered is poured into the top part of the drum of the filter with the necessary infeeding system, which can be a feeder box (10) or a large-sized cylinder (10a), which together with the drum and end walls form a space into which the sludge can be fed. If a feeder box is used, it is sealed such that sludge does not penetrate between the drum and the feeder box. If a cylinder solution is used, the surface of the cylinder is manufactured from a flexible material, which presses against the drum and prevents the sledge from flowing away. Likewise the ends of the space are sealed.

When a filterpress cake has been formed in the feeder apparatus from the sludge to be filtered, cake drying follows. After drying, the cake is removed from the surface of the drum with a doctor blade (11), a wire or a separate strip, which follows the drum throughout the filtration cycle.

The drum filter further comprises a tank (12) in which the bottom part of the drum is submerged. Cleaning of the filter elements is arranged in the tank from one of the following methods or a combination of them:

The tank comprises an ultrasound washer (13), which cleans the filter elements with the wash liquid in the tank. The wash liquid can be e.g. water, into which wash chemicals are periodically mixed from a reservoir disposed near the filter. After washing, the wash liquid is either released into a sewer or it is pumped back into the reservoir for cleaning and regeneration. An alternative solution, or as a combination with what is presented above, comprises wash nozzles (13a) in the tank, which wash nozzles spray wash liquid onto the filter elements with pressure.

The cleaning of the filter elements can be either intermittent or continuous. Intermittent cleaning occurs at fixed intervals, e.g. once an hour or once per 24 hours, depending on the need. In continuous cleaning, the cleaning method is in use all the time. The cleaning can also be intermittently continuous, i.e. the cleaning is in use for intervals of e.g. 10 minutes or an hour, and in between is e.g. a break of 3 hours.

In the cleaning presented above the detached dirt is mixed with the cleaning liquid and it is removed by circulating the cleaning liquid via a separate filter (14).

### DETAILED DESCRIPTION OF THE INVENTION

Conventional drum filters that operate on the top-feed principle have generally been described in prior art. It should be noted that a filter fabric functions as the filter medium in these, which allows air to pass through and, this being the case, the energy consumption of the filter is high. It is very important to note that apparatuses for cleaning the filter medium that are based on ultrasound technology or the use of chemical solutions are not used in prior-art top-feed filters.

As has been disclosed earlier, it is awkward to arrange continuous cleaning of the filter elements in the filters described by prior art, because in this case the cleaning apparatus must work when submerged in the sludge. In the solution according to the invention the bottom part of the drum of the filter is bare and thus is easy to clean with ultrasound or with water-based chemical solutions.

The patent publication FI 77382, which also presents a drum filter that is partly of the same type, describes local prior art. From the standpoint of the invention, however, the most essential differences are the following:

Differing from the solution according to the invention, cake formation occurs by raising the filterpress cake from the sludge tank. The most essential difference however is that a prior-art filter does not comprise any cleaning method for the filter elements. In the filter according to the publication, it is not possible to arrange a cleaning system according to the invention of this application.

As a result of this the advantages of the invention with respect to prior art are the following:

With the solution according to the invention it is possible to process heavy and/or large particles, the lifting of which from the tank would otherwise be difficult or impossible owing to their weight or their flow properties (drag force). By means of the solution it is now possible to process very dense sludges, such as iron sludge, the density of which is 75% by weight. In addition, it is possible to filter substances that cause rapid clogging in the filter elements (e.g. fine-grained and gelatinous organic or inorganic substances). This advantage is achieved as a result of the versatile and, if necessary continuously-operating, cleaning system of the invention.

The filter according to the invention is provided with different cleaning apparatuses such as ultrasound cleaning, chemical cleaning and pressure washing nozzles, so that the capacity of the filter can now be kept constant. In addition, the filter operates on the capillary filtration principle and because of this a very small vacuum pump is needed for maintaining the partial vacuum of the filter. Energy consumption is low, the filtrate is free of solid material and the residual moisture achieved is low.

The following examples describe the preferred use of the solution according to the invention and present the viability of the method for cleaning the apparatus. The examples are only to elucidate the invention, so that the applications of the invention are not limited to them but instead they can be varied within the scope of the description of the application and the protective scope of the claims.

### Example 1

The filter according to the invention filters magnetite concentrate, the particle size of which is 100 micrometers and the density of the infeed of the filter is 75% by weight. The infeed of the sludge occurs via a feeder box. The filterpress cake is removed with a doctor blade. The residual moisture of the filterpress cake is 9% and the filtration capacity 4000 kg/m2h. After six hours of filtration the infeed of sludge is interrupted and washing solution, which contains 2% nitric acid and 4% oxalic acid and the temperature of which is 50 C, is pumped into the tank of the filter. When the tank is full, the ultrasound vibrators in the bottom of the tank are started and a combined ultrasound wash and acid wash is performed for 10 minutes. After the wash, the acid solution in the tank is pumped back into the storage reservoir via the filter, which separates the solid matter from the solution. The infeeding of sludge continues.

### Example 2

The filter according to the invention filters magnetite concentrate, the particle size of which is 100 micrometers and the density of the infeed of the filter is 68% by weight. The infeed of sludge occurs via a feeder box. The filterpress cake is removed with a doctor blade. The residual moisture is 9% and the filtration capacity with a clean filter medium is 3300-3500 kg/m2h. If the filtration is continued without cleaning of the filter elements, the capacity of the filter decreases in 10 hours to the level of 2000 kg/m2h. If an ultrasound wash is performed by means of the ultrasound vibrators disposed in the bottom of the tank and the tank contains process water without washing agent, the filtration capacity ranges between 3000-3500 kg/m2h. The duration of the ultrasound wash in this case is 2 minutes and it is performed at intervals of 2 hours.

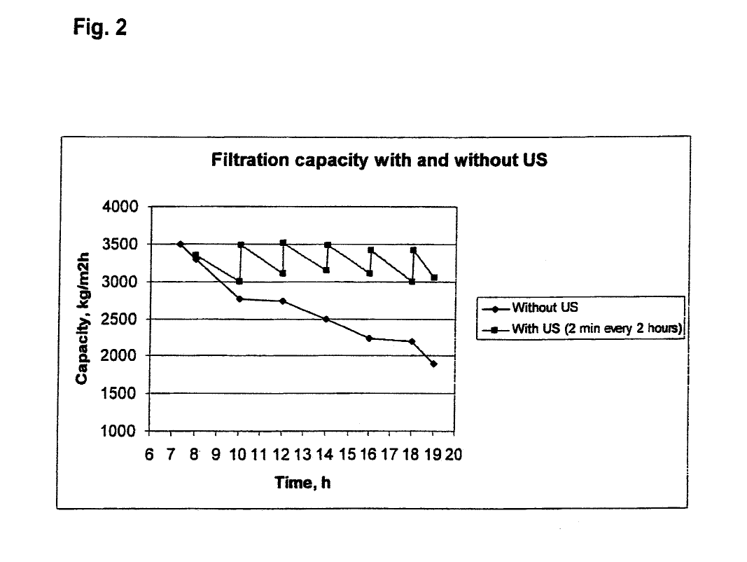

FIG. 2 presents cleaning according to example 2. The figure shows the capacity of the filter according to the invention as a function of time both without ultrasound cleaning and with ultrasound cleaning.

### Example 3

The filter according to the invention filters fine-grained chemical precipitate, the particle size of which is in the range of 1-5 micrometers. Without cleaning of the filter elements, the fine particles will rapidly clog the filter medium. The tank of the filter contains filtrate water continuously and the ultrasound vibrators of the filter are in operation continuously. The capacity of the filter remains almost constant with a small downward trend. Cleaning with a combined ultrasound wash and chemical wash is performed at intervals of 24 hours.

The examples presented above disclose the indisputable advantages of the solution according to the invention, its novelty and its inventive step. It is obvious to the person skilled in the art that the solution according to the invention is not limited solely to the examples described above, but that it may be varied within the scope of the attached claims.

1. A method for cleaning a filter medium, comprising:
causing the filter medium's presence in a basin;
conducting a washing liquid from a container into the basin through a washing liquid inlet of the basin; and
conducting the washing liquid from the basin back to the container following the filter medium's exposure to the washing liquid in the basin for a predetermined duration.

2. A method according to claim 1, wherein the washing liquid comprises an active component, and the method comprises:
determining the concentration of the active component in the washing liquid stored in the container prior to conducting the washing liquid into the basin.

3. A method according to claim 2, comprising:
in case the determined concentration of the active component does not meet a predetermined criterion, adjusting the concentration of the active component in the washing liquid stored in the container by adding said active component and/or dilute liquid into the washing liquid.

4. A method according to claim 3, comprising:
carrying out a plurality of determinations of said concentration of the active component during the washing liquid's residence in the container; and
adjusting the concentration of the active component in the washing liquid following a determination of any of said plurality of determinations that the concentration does not meet the predetermined criterion.

5. A method according to claim 1, comprising:
rinsing the basin with a rinsing liquid prior to conducting the washing liquid into the basin.

6. A method according to claim 1, comprising:
determining the temperature of the washing liquid prior to conducting it from the container into the basin.

7. A method according to claim 1, comprising:
determining the temperature of the washing liquid in the basin.

8. A method according to claim 6, comprising:
in case the determined temperature does not meet a predetermined criterion, adjusting the temperature of the washing liquid prior to conducting it from the container into the basin.

9. A method according to claim 6, comprising:
in case the determined temperature does not meet a predetermined criterion, adjusting the temperature of the washing liquid in the basin

10. A method according to claim 1, comprising:
exposing the filter medium in the basin to cavitation occurring in the washing liquid in proximity of the filter medium due to ultrasonic waves introduced into the washing liquid.

11. A method according to claim 1, comprising:
causing the filter media to move through the washing liquid in the basin.

12. A method according to claim 11, wherein the filter media comprises a filter plate forming a part of a rotatable filter disk, and the method comprises:
causing the filter media to submerge into, move in, and emerge from the washing liquid by rotating the filter disk.

13. A method according to claim 5, wherein the basin comprises a common basin for the washing liquid and a suspension to be processed using at least the filter medium, and the method comprises:
removing a residue of said suspension from the basin prior to rinsing the basin with the rinsing liquid.

14. A method according to claim 1, comprising:
removing particle residues due to the filter medium's exposure to the washing liquid from the washing liquid being conducted back into the storage container.

15. A method according to claim 2, wherein the active component is selected from a group consisting of an acid component, an alkali component, a complexing solvent component, an oxidizing agent component, and a reducing agent component.

16. An apparatus for cleaning a filter medium comprising:
a basin;
a washing liquid inlet provided on a wall of the basin;
a mounting structure for causing the filter medium's presence in the basin for a predetermined duration;
a washing liquid container for storing a washing liquid, said container being in communication with the basin through a washing liquid conduit connected to the washing liquid inlet; and
a pump for causing the washing liquid to flow from said container into the basin, and following the predetermined duration, for causing the washing liquid to flow from the basin back to said container.

17. An apparatus according to claim 16, wherein the washing liquid comprises an active component, and the apparatus comprises:
a concentration measuring device adapted to determine the concentration of the active component of the washing liquid stored in the washing liquid container.

18. An apparatus according to claim 17, wherein the washing liquid container comprises:
a concentrate inlet for admission of a concentrate comprising the active component into the washing liquid container; and
a dilute liquid inlet for admission of a dilute liquid into the washing liquid container.

19. An apparatus according to claim 18, comprising:
a controller adapted to be in operative communication with the concentration measuring device, the controller being configured to receive concentration data from the measuring device and to automatically control admission of the concentrate and/or the dilute liquid into the washing liquid container.

20. An apparatus according to claim 19, wherein the apparatus further comprises a display, and the controller is configured to show the concentration data, either processed or unprocessed, on said display.

21. An apparatus according to claim 16, wherein the basin comprises a rinsing liquid inlet for admitting a rinsing liquid into the basin.

22. An apparatus according to claim 16, comprising:
a temperature measuring device adapted to determine the temperature of the washing liquid residing in the washing liquid container.

23. An apparatus according to claim 16, comprising:
a temperature measuring device adapted to determine the temperature of the washing liquid residing in the basin.

24. An apparatus according to claim 22, wherein the temperature measuring device is adapted to be in operative communication with the controller and wherein the controller is configured to receive temperature data from the temperature measuring device.

25. An apparatus according to claim 24, wherein the apparatus further comprises a heating element being in operative communication with the controller, and the controller is configured to control the operation of the heating element in response to receiving said temperature data.

26. An apparatus according to claim 16, wherein the basin further comprises a transducer adapted to convey ultrasonic waves into the washing liquid during at least a portion of the washing liquid's residence time in the basin.

27. An apparatus according to claim 26, wherein the transducer is in operative communication with the controller, and wherein the controller is configured to control the transducer to convey said ultrasonic waves.

28. An apparatus according to claim 19, wherein the pump is in operative communication with the controller, and the controller is configured to control the pump to enable the flow of the washing liquid between the washing liquid container and the basin.

29. An apparatus according to claim 16, wherein the filter medium comprises a filter plate and the mounting structure comprises a rotatable filter disk structure, the filter plate being adapted to be mounted thereto.

30. An apparatus according to claim 29, wherein the rotatable filter disk is adapted to rotate from a first position to a second position such that said rotation causes the filter plate to submerge into, move through, and emerge from the washing liquid residing in the basin.

31. An apparatus according to claim 16, comprising:
a particle filter being in communication with the washing liquid conduit and adapted to remove solid particles from the washing liquid being conducted to the washing liquid container.

32. An apparatus according to claim 16, wherein the active component is selected from a group consisting of an acid component, an alkali component, a complexing solvent component, an oxidizing agent component, and a reducing agent component.
